(19) United States
(12) Patent Application Publication
(10) Pub. No.: US 2026/0065483 A1
(43) Pub. Date: Mar. 5, 2026

(54) METHODS OF ENHANCING MULTIDIMENSIONAL TIME SERIES ANALYSIS

(71) Applicant: The Children's Medical Center Corporation, Boston, MA (US)

(72) Inventors: Kwonmoo Lee, North Billerica, MA (US); Daehyung Kim, Boston, MA (US)

(73) Assignee: The Children's Medical Center Corporation, Boston, MA (US)

(21) Appl. No.: 19/311,954

(22) Filed: Aug. 27, 2025

Related U.S. Application Data
(60) Provisional application No. 63/687,975, filed on Aug. 28, 2024.
(60) Provisional application No. 63/772,255, filed on Mar. 14, 2025.

(51) Int. Cl. G06T 7/00; G06T 7/11; G06T 7/168

(52) U.S. Cl. CPC G06T 7/0016; G06T 7/11; G06T 7/168; G06T 2207/10004; G06T 2207/20036; G06T 2207/20081; G06T 2207/20084; G06T 2207/30024

(57) ABSTRACT

This disclosure includes improved methods for classifying cell type from time-series live-cell imaging data.

### RELATED APPLICATIONS

This application claims priority under 35 U.S.C. § 119(e) to U.S. Provisional Patent Application No. 63/772,255, filed Mar. 14, 2025, entitled “METHODS OF ENHANCING MULTIDIMENSIONAL TIME SERIES ANALYSIS,” and U.S. Provisional Patent Application No. 63/687,975, filed Aug. 28, 2024, entitled “METHODS OF ENHANCING MULTIDIMENSIONAL TIME SERIES ANALYSIS,” each of which is incorporated by reference herein in its entirety.

### FEDERALLY SPONSORED RESEARCH

This invention was made with government support under Grant no. GM133725, awarded by The National Institutes of Health. The government has certain rights in the invention.

### BACKGROUND

A central challenge in analyzing life cell imaging data is extracting biologically relevant information while preserving the heterogeneity that exists in living cells. This is a challenge because data processing methods typically use dimension reduction methods to make the data more suitable for analysis, however, reducing the dimensionality of the live cell imaging data can also remove biological relevant heterogeneity, which in turn can impact conclusions drawn from the imaging data (e.g., whether a cell is a cancer cell).

### SUMMARY

This disclosure includes methods for classifying the cell type of cells using live cell imaging data and machine learning algorithms. These methods improve upon the accuracy of existing cell type classification methods. Without being bound to theory, this improvement is a result of developing live cell imaging data analysis methods that maintain the heterogeneity of live cells better than existing methods. In some embodiments, the trajectory embedding methods disclosed herein track state transitions and utilize stochastic characterization to better identify temporal cell heterogeneity in live cell imaging methods. Additionally, this disclosure provides methods for converting time series data (e.g., live cell imaging data) into a collection of transitions (e.g., a transition map), which makes different time series data quantitatively comparable.

In some aspects, this disclosure provides a method for identifying cell types of one or more cells in a plurality of cells from a series of images of the plurality of cells, the method comprising: using at least one computer hardware processor to perform: obtaining the series of images of the plurality of cells, the series of images of the plurality of cells having been previously captured; segmenting images in the series of images of the plurality of cells to obtain segmented cell data, the segmented cell data comprising segmented image data for each of at least some of the plurality of cells; identifying each particular cell of the at least some of the plurality of cells as being of a type from a discrete set of cell types, the identifying being performed using segmented image data for the particular cell and a trained neural network model comprising an encoder portion and a classification portion, the identifying comprising: deriving, from the segmented image data for the particular cell, a plurality of feature value trajectories for a respective plurality of features; processing the plurality of feature value trajectories using the encoder portion of the trained neural network model to obtain a numeric embedding of the plurality of feature value trajectories; and processing the numeric embedding using the classification portion of the trained neural network model to identify the type of the particular cell.

In some embodiments, the encoder portion of the trained neural network has a transformer based architecture. In some embodiments, the encoder portion comprises multiple attention heads. In some embodiments, the classification portion of the trained neural network comprises at least one fully connected layer. In some embodiments, the plurality of features includes cell area, major length, minor length, perimeter, convex Area, PCA 0, abs. velocity, major axis velocity, and minor axis velocity; wherein the segmented cell data comprises segmented image data for a first cell of the at least some of the plurality of cells; wherein the segmented image data for the first cell comprises a sequence of images of the first cell; and wherein deriving the plurality of feature value trajectories for the first cell comprises deriving feature values, for each of the plurality of features, from each of the images of the sequence of images of the first cell.

In some embodiments, the method further comprises training the trained neural network model, the training comprising: generating training data for training the encoder portion; and training the encoder portion using the generated training data.

In some embodiments, generating the training data comprises: generating a training set of feature value trajectories from image data of cells; generating a set of transition maps from the training set of feature value trajectories; and determining distances among feature value trajectories in the training set of feature value trajectories by computing a measure of distance among transition maps in the set of transition maps generated from the training set of feature value trajectories.

In some embodiments, generating the set of transition maps from the training set of feature value trajectories comprises generating a first transition map in the set of transition maps from a first feature value trajectory in the set of feature value trajectories, wherein generating the first transition map from the first feature value trajectory comprises: determining in a set of states defined in feature space having fewer dimensions than the number of features in the plurality of features, a transition probability matrix among the set of states based on how the first feature value trajectory overlaps with the set of states.

In some embodiments, the measure of distance is a histogram distance measure, optionally wherein the measure of distance is Earth mover's distance.

In some embodiments, training the encoder portion using the generated training data comprises: training a Siamese transformer network to estimate distances between pairs of feature value trajectories, from among the training set of feature value trajectories, as inputs and determined distances among the feature value trajectories as outputs, wherein the Siamese transformer network comprises the encoder portion.

In some embodiments, training the Siamese transformer network is performed using mean-squared error (MSE) loss and/or binary cross entropy loss. In some embodiments, the Siamese transformer network further comprises a cell matching check network layer. In some embodiments, the method further comprises training the classification portion of the trained neural network.

In some embodiments, this disclosure provides a method for identifying cell types of one or more cells in a plurality of cells from a series of images of the plurality of cells, the method comprising: using at least one computer hardware processor to perform: obtaining the series of images of the plurality of cells, the series of images of the plurality of cells having been previously captured; segmenting images in the series of images of the plurality of cells to obtain segmented cell data, the segmented cell data comprising segmented image data for each of at least some of the plurality of cells; identifying each particular cell of the at least some of the plurality of cells as being of a type from a discrete set of cell types, the identifying being performed using segmented image data for the particular cell, a trained encoder neural network model, and a trained classification model, the identifying comprising: deriving, from the segmented image data for the particular cell, a plurality of feature value trajectories for a respective plurality of features; processing the plurality of feature value trajectories using the trained encoder neural network model to obtain a numeric embedding of the plurality of feature value trajectories; and processing the numeric embedding using the trained classification model to identify the type of the particular cell.

In some embodiments, the trained classification model is a neural network model, a support vector machine, a linear regression model, a non-linear regression model, a Bayesian model, or a graphical model.

In some embodiments, the series of images of the plurality of cells was previously captured using widefield fluorescence, confocal, multiphoton, total internal reflection, FRET, lifetime imaging, super-resolution, and/or transmitted light microscopy.

In some embodiments, the method further comprises: capturing the series of images of the plurality of cells.

In some embodiments, this disclosure provides a method of converting time series data into a transition map, the method comprising: obtaining time series data; extracting a plurality of features from the time series data; deriving a plurality of feature value trajectories for a respective plurality of the extracted features; reducing the dimensions of the plurality of feature value trajectories to obtain reduced dimension feature value trajectories; converting the reduced dimension feature value trajectories into a chain of states; and determining transitions between states in the chain of states to produce a transition map.

In some embodiments, obtaining the time series data comprises obtaining a series of images of the plurality of cells; and wherein extracting the features from the time series data comprises extracting cell morphodynamics features.

In some embodiments, the method further provides training a machine learning model using the transition map. In some embodiments, converting time series data comprises converting first time series data to produce a first transition map and converting second time series data to produce a second transition map. In some embodiments, the method comprises training a machine learning model using a measure of distance between the first transition map and the second transition map.

In some embodiments, training the machine learning model comprises training the machine learning model to determine a distance between the first transition map and the second transition map. In some embodiments, this disclosure provides a system, comprising: at least one computer hardware processor; and at least one non-transitory computer-readable storage medium that, when executed by the at least one computer hardware processor, causes the at least one computer hardware processor to perform a method described herein. In some embodiments, this disclosure provides at least one non-transitory computer-readable storage medium that, when executed by at least one computer hardware processor, causes the at least one computer hardware processor to perform a method described herein.

### BRIEF DESCRIPTION OF DRAWINGS

The accompanying drawings are not intended to be drawn to scale. For purposes of clarity, not every component may be labeled in every drawing. In the drawings:

FIGS. 1A-1C are exemplary flow charts depicting a method of cell type classification described herein. FIG. 1A is depicts a method of classifying cell type using a transformer-based feature extraction model (encoder portion) and a cell prediction model (classification portion).

FIG. 1B is an exemplary schematic of the transformer-based feature extraction model. FIG. 1C is an exemplary schematic of the cell prediction model.

FIG. 2 is an exemplary depiction of time-series live-cell imaging data for normal (MCF10A) and breast cancer (MDA-MB-231) cells and exemplary features of that data.

FIGS. 3A-3B show an exemplary process of determining feature value trajectories. FIG. 3A is an exemplary process for identifying features to use in a cell type prediction method. FIG. 3B shows different features of cells and corresponding differences in cluster location by feature when clustered by 2D Uniform Manifold Approximation and Projection (UMAP).

FIG. 4 is an exemplary diagram showing a one dimensional example of producing transition map from in silico generated Fluorescence resonance energy transfer (FRET) data.

FIGS. 5A-5D show a diagram illustrating an example of producing a transition map between cellular states (e.g., cellular morphology) using cell trajectory features, and corresponding results. FIG. 5A show an exemplary method for determining a cell transition map from cell trajectory features. UMAP analysis of the transition map differentiates between healthy and cancerous cells. FIGS. 5B-5C show UMAP analysis of the transition map identifies different clusters of cells that relate to different cell morphologies. FIG. 5D shows the locations of the clusters in the UMAP analysis and the corresponding cell morphology.

FIG. 6 show an exemplary flow chart depicting a process for training the transformer-based feature extraction model and corresponding results based on the distance measure used.

FIGS. 7A-7D show exemplary UMAP analysis of ground truth distance data and distance data obtained using the transformer-based feature extraction model. FIG. 7A shows UMAP based on the true distance matrix. FIG. 7B shows UMP based on the extracted feature produced by the transformer-based feature extraction model without using the label branching model.

FIG. 7C shows UMAP based on the true distance matrix. FIG. 7D shows UMP based on the extracted feature produced by the transformer-based feature extraction model with using the label branching model.

FIG. 8 is an exemplary diagram of a cell matching check model, which is used in training of the transformer-based feature extraction model.

FIG. 9 is a diagram showing improvement in breast cancer cell type classification after different data processing acts of an exemplary method for classifying cell type. Cell type classification at intermediate acts was performed using Adaboost.

FIG. 10 is a diagram depicting illustrative technique 1000 for using a trained neural network model to classify the cell type of a cell.

FIG. 11 is a diagram depicting illustrative technique 1100 for generating training data that can be used to train an encoder portion of a trained neural network model.

FIG. 12 depicts an illustrative implementation of a computer system that may be used in connection with some embodiments of the technology described herein.

FIGS. 13A-13D show examples of producing feature trajectories and transition maps. FIG. 13A shows a montage plot of MCF10A cell. FIG. 13B shows two examples of PHet selected snapshot features trajectories. FIG. 13C shows a trajectory of snapshot UMAP, the color gradient of the trajectory indicates the time shown in FIG. 13B. FIG. 13D shows a transition map plot of the UMAP trajectory (C).

FIGS. 14A-14C shows example of transition map comparison. FIG. 14A shows three examples of snapshot UMAP trajectories. FIG. 14B shows three examples of the transition maps from the trajectories indicated in 14A. FIG. 14C shows a time series UMAP based on Earth Mover's Distance base metric between transition maps.

### DETAILED DESCRIPTION

Cell motility and morphodynamics (e.g., cell area, perimeter, and velocity) play a critical role in cancer, offering profound insights into the complex behaviors of cancer cells. Motility, the capability of cells to move, and morphodynamics, the study of changes in cell morphology over time, are pivotal in understanding cancer progression, particularly in the context of metastasis and invasiveness. These phenomena are not merely passive attributes but are active drivers of cancer cell differentiation, invasion, and the ability to dynamically interact with and navigate through the microenvironment. The distinct motility phenotypes can indicate the metastatic potential of cancer cells, with certain patterns of movement being characteristic of highly invasive cancers such as osteosarcoma, breast, and prostate cancer cells. Similarly, the study of morphodynamics provides invaluable information on how cancer cells adapt their shape and size during invasion and metastasis, a critical aspect of cancer progression. Particularly, the morphodynamics of breast cancer cells in 2D environments was reported to correlate well with their motility in 3D environments. Despite their significance, systematically characterizing cell motility and morphodynamics in cancer has been challenging, primarily due to their inherent heterogeneity. Addressing this challenge requires advanced computational techniques capable of integrating multimodal features across various spatiotemporal scales.

Live cell imaging emerges as a pivotal technique for unraveling the intricacies of dynamic cellular processes in cancer research, offering insights across varied spatiotemporal dimensions that static imaging modalities fail to capture. Nonetheless, the inherent phenotypic heterogeneity within cancerous tissues—where multiple, distinct cell phenotypes persist under identical conditions—presents significant challenges in analyzing and interpreting live cell imaging data. This heterogeneity complicates the task of accurately detecting cancer and deciphering the reasons behind the disparate outcomes of cancer therapies among patients. To navigate through the complexities introduced by phenotypic heterogeneity, there is a pressing need for computational methodologies capable of unveiling previously unrecognized cellular phenotypes from live cell images. Traditional approaches often involve classifying known phenotypes. However, conventional feature selection methods primarily focus on isolating features that facilitate the classification of already identified phenotypes, inadvertently overlooking the heterogeneity, and consequently compressing the phenotypic landscape. This limitation restricts effective subtyping and the exploration of the full spectrum of cancer cell behaviors. Deep Neural Networks (DNNs) represent a more advanced solution, with the ability to learn intricate feature sets directly from raw data. This capability allows DNNs to encapsulate a broader array of information from complex datasets, potentially overcoming the limitations of traditional methods. Nevertheless, the common practice of employing supervised learning in DNNs encounters similar obstacles in preserving the heterogeneity associated with unclassified cellular subtypes. To harness the capabilities of live cell imaging in cancer research and surmount the obstacles posed by phenotypic heterogeneity, this disclosure provides methods of classifying cell type using feature extraction techniques and machine learning models that maintain subtype heterogeneity while effectively distinguishing between recognized cancer phenotypes.

These methods involve processing live cell imaging data to extract feature value trajectories associated with at least some of the cells imaged. Features are typically selected based on the features ability to identify the cell type of interest (e.g., using the PHet algorithm). Features may include cell area, major length, minor length, perimeter, convex Area, PCA 0, abs. velocity, major axis velocity, and minor axis velocity. The feature value trajectory is a measure of the features across the time course of the experiment. For example, if the live cell imaging comprised 150 images taken over the course of an hour and 9 features were selected then a typical feature value trajectory would be a 9 by 150 matrix of values. If 1000 cells are analyzed then then dimensionality of all the feature value trajectories would be 9 by 150 by 1000.

The method continues with processing the feature value trajectories to classify cell type using a machine learning model. Typically, the machine learning model has two different portions: and encoder portion and a classification portion. Alternatively, the method may comprise two different machine learning models, the first comprising the encoder portion and the second comprising the classification portion. For a given cell and corresponding feature value trajectory, the encoder portion (e.g., a trained neural network) is used to process the feature value trajectory to obtain a numeric embedding. Numeric embeddings convert high dimensional data (e.g., a feature value trajectory) into lower dimensional data, which can improve similarity searching with machine learning algorithms (e.g., classification). The numeric embedding is then processed using the classification portion to determine cell type.

It can be challenging to properly train an encoder to produce an accurate numeric embedding of feature value trajectory (e.g., a numeric embedding which captures features that are important to cell type classification). To address this problem, this disclosure provides methods of training the encoder portion of a machine learning model (e.g., a transformer neural network). Training the encoder may include generating a set of transition maps from a training set of feature value trajectories, determining a distance (e.g., an earth mover's distance) between pairs of the transition maps to produce a ground truth of the distance between the pair of feature value trajectories, computing a pair of numeric embeddings for the pair of feature value trajectories that corresponds to the pair of transition maps using the encoder, determining the distance between the pair of numeric embeddings (e.g., using Euclidian distance and/or a cell matching check neural network), and comparing that to the ground truth distance (e.g. using one or more loss functions such as mean-squared error (MSE) or cross-entropy loss). Determining a transition maps may include determining, in a set of states defined in a feature space having fewer dimensions (e.g., 2 dimensions) than the number of features in feature value trajectories (e.g., 9 dimensions), a transition probability matrix among the set of states based on how the first feature value trajectory overlaps with the set of states. In some embodiments, the feature value trajectory is divided into discrete grids and a state transition (of the state transition map) is defined as a movement between temporally adjacent grid states.

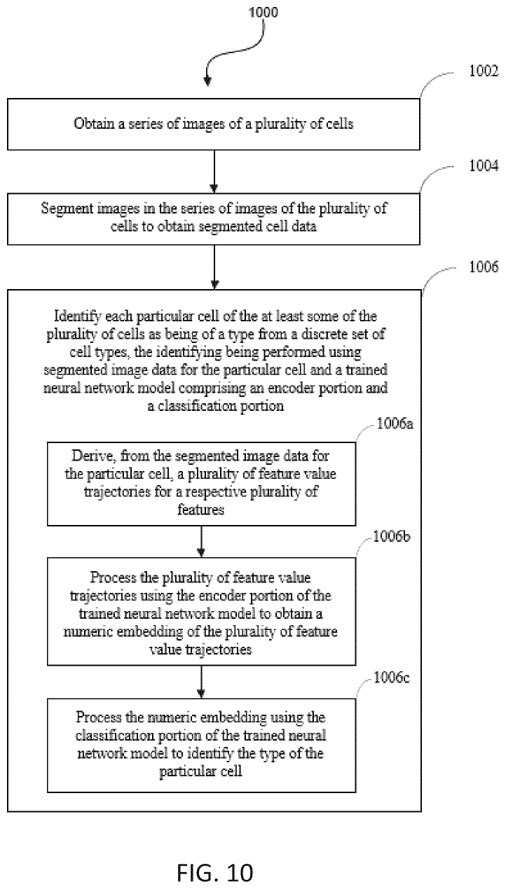

FIG. 10 is a diagram depicting illustrative technique 1000 for using a trained neural network to identify cell types of one or more cells in a plurality of cells from a series of images of the plurality of cells.

Technique 1000 involves act 1102, obtaining a series of images of a plurality of cells. Obtaining a series of images of a plurality of cells may be performed in any suitable way. In some embodiments, obtaining a series of images (e.g., a time series of images) comprises obtaining a series of images captured by one or more of widefield fluorescence, confocal, multiphoton, total internal reflection, FRET, lifetime imaging, super-resolution, and transmitted light microscopy. In some embodiments, obtaining a series of images of a plurality of cells comprises obtaining the images from a third party who captured the images. In some embodiments, obtaining a series of images of a plurality of cells comprises obtaining the images from a datastore. In some embodiments, obtaining a series of images of a plurality of cells comprises capturing the images. Capturing a series of images of a plurality of cells may be performed in any suitable manner. In some embodiments, capturing a series of images of a plurality of cells comprising capturing using one or more of widefield fluorescence, confocal, multiphoton, total internal reflection, FRET, lifetime imaging, super-resolution, and transmitted light microscopy. In some embodiments, obtaining a series of images of a plurality of cells comprises obtaining time-lapse images of a plurality of live cells. In some embodiments, obtaining a series of images of a plurality of cells comprises obtaining images of a 2-dimensional cell culture comprising the plurality of cells. In some embodiments, obtaining a series of images of a plurality of cells comprises obtaining images of a 3-dimensional cell culture comprising the plurality of cells. In some embodiments, obtaining a series of images of a plurality of cells comprises obtaining images of a specimen obtained from a subject (e.g., a biopsy obtained from a human subject). In some embodiments, obtaining a series of images of a plurality of cells comprises obtaining images of a tissue (e.g., a tissue biopsy of a human subject). In some embodiments, obtaining a series of images of a plurality of cells comprises obtaining images of any suitable plurality of cells (e.g., Epithelial Cells, Squamous Epithelium, Cuboidal Epithelium, Columnar Epithelium, Fibroblasts, Adipocytes, Chondrocytes, Osteocytes, Skeletal Muscle Cells, Cardiac Muscle Cells, Smooth Muscle Cells, Sensory Neurons, Motor Neurons, Interneurons, Red Blood Cells (Erythrocytes), White Blood Cells (Leukocytes), Platelets (Thrombocytes), Embryonic Stem Cells, and/or Adult Stem Cells). In some embodiments, obtaining a series of images of a plurality of cells comprises obtaining images of a plurality of cells comprising cancer cells (e.g., brain cancer cells, lung cancer cells, liver cancer cells, pancreatic cancer cells, colon cancer cells, stomach cancer cells, breast cancer cells, blood cancer cells, lymph node cancer cells, testicular cancer cells, ovarian cancer cells, uterine cancer cells, prostate cancer cells, bone cancer cells, or skin cancer cells). In some embodiments, obtaining a series of images of a plurality of cells comprises obtaining images of a plurality of cells comprising cancer cells and non-cancerous cells. In some embodiments, obtaining a series of images of a plurality of cells comprises obtaining images of a plurality of cells comprising multiple types of cells (e.g., normal breast cells and cancer breast cells). A cell type describes cells that share a common morphological and/or phenotypical feature. For an example, a cell can be a cancer cell type or a normal (i.e., non-cancerous) cell type. In another example, cells of different organs can be different cell types (e.g., a pancreases cell type vs. a liver cell type). In another example, cells of a particular organ (e.g., the liver) can be different cell types (e.g., hepatocytes, liver sinusoidal endothelial cells, hepatic stellate cells, Kupffer cells, etc.). In some embodiments, the plurality of cells comprises at least 2 (e.g., at least 3, at least 5, at least 10, or at least 20) different cell types. In some embodiments, obtained images of a plurality of cells may comprise images of at least 10 cells (e.g., at least 50 cells, at least 100 cells, at least 500 cells, at least 1000 cells, at least 10,000 cells, or at least 100,000 cells).

Technique 1000 continues with act 1004, segmenting images in the series of images of the plurality of cells to obtain segmented cell data. Segmenting includes the process of identifying and separating an image of an individual cell from other images of cells within a larger image. Any suitable method may be used to segment images. Method of segmenting images to obtain segmented cell data are known in the art, e.g., as described in Wen, Tingxi, et al. Computer methods and programs in biomedicine 227 (2022): 107211. In some embodiments, segmenting images in the series of images of the plurality of cells to obtain segmented cell data comprises segmenting using MARS-Net, e.g., as described in Jang J et al., STAR Protoc. 2022 Jun. 14;3(3):101469. PMCID: PMC9207580. In some embodiments, the segmented cell data comprises segmented cell data for a plurality of cells (e.g., least 2 cells, least 5 cells, least 10 cells, at least 50 cells, at least 100 cells, at least 500 cells, at least 1000 cells, at least 10,000 cells, or at least 100,000 cells). In some embodiments, segmented cell data comprises a sequence of segmented images of a cell (e.g., a sequence of images that are ordered accordingly to the time series acquisition of the images). In some embodiments, segmented cell data comprises a sequence of segmented images of a plurality of cells.

Technique 1000 continues with act 1006, identifying each particular cell of the at least some of the plurality of cells as being of a type from a discrete set of cell types, the identifying being performed using segmented image data for the particular cell and a trained neural network model comprising an encoder portion and a classification portion. In some embodiments, identifying each particular cell of the at least some of the plurality of cells comprises identifying at least 10% (e.g., at least 25%, at least 50%, at least 75%, at least 90%, at least 95%, at least 98% or at least 99%) of the cells of the plurality of cells. In some embodiments, identifying each particular cell of the at least some of the plurality of cells comprises identifying 100% of the cells of the plurality of cells. In some embodiments, a discrete set of cell types refers to at least two cell types (e.g., a cancer cell type and a normal cell type). In some embodiments a discrete set of cell types refers to a cancer cell type and a normal cell type from the same organ (e.g., a breast cancer cell type and a normal breast cell type). In some embodiments, a discrete set of cell types refers to cell types of different organs of a subject (e.g., a liver cell type, a pancreas cell type, a stomach cell type, and/or a lung cell type). Discrete set of cell types refers to different cell types of the same organ (e.g., hepatocytes, liver sinusoidal endothelial cells, hepatic stellate cells, and Kupffer cells). In some embodiment, identifying each particular cell of the at least some of the plurality of cells as being of a type from a discrete set of cell types, the identifying being performed using segmented image data for the particular cell, a machine learning model comprising: (i) a trained neural network model comprising an encoder portion, (i) a classification portion. In some embodiments, the classification portion comprises neural network model, a support vector machine, a linear regression model, a non-linear regression model, a Bayesian model, and/or a graphical model.

Act 1006 includes sub-acts 1006a, 1006b, and 1006c. Sub-act 1006a includes deriving, from the segmented image data for the particular cell, a plurality of feature value trajectories for a respective plurality of features. The plurality of feature value trajectories for the respective plurality of features may be derived in any suitable way. In some embodiments, deriving the plurality of feature value trajectories for the first cell comprises deriving feature values, for each of the plurality of features, from each of the images of the sequence of images of the first cell. In some embodiments, deriving feature value trajectories from a series of images of the plurality of cells, comprises deriving structural and/or morphodynamic features of the cells (e.g., cell perimeter, cell area, minor length, major length, and/or velocity). In some embodiments, selecting a respective plurality of features comprises selecting features that differentiate between different cell types of the discrete set of cell types. For example, if a task of the method is to classify a cell as a normal breast cell or a cancerous breast cell then the respective plurality of features may be selected according to structural and/or morphodynamic characteristics that differentiate normal and cancerous breast cells. In some embodiments, selecting the respective plurality of features comprises selecting using the Preserving Heterogeniety (PHET) algorithm e.g., as described in Basher ARMA, bioRxiv 2023 Dec. 20:2023.05.14.540686. PMCID: PMC10769187. In some embodiments, the respective plurality of features comprises 1, 2, 3, 4, 5, 6, 7, 8, 9, 10, 11, 12, 13, 14, 15, 16, 17, 18, 19, 20 or more features. In some embodiments, the respective plurality of features comprises at least 2 features (e.g., at least 5 features, at least 10 features, at least 15 features, or at least 20 features). In some embodiments, the respective plurality of features comprises one or more of cell area, major length, minor length, perimeter, convex Area, PCA 0, abs. velocity, major axis velocity, and minor axis velocity. In some embodiments, the respective plurality of features comprises each of cell area, major length, minor length, perimeter, convex Area, PCA 0, abs. velocity, major axis velocity, and minor axis velocity. In some embodiments, the feature value trajectory for each cell comprises a value for each feature in each image of the series of images. For example, if there were 9 features, and 100 images, then the plurality of feature value trajectories for a given cell would comprise 9 by 100 values. If 1000 cells were analyzed then the plurality of feature value trajectory for all the cells would be 9 by 100 by 1000.

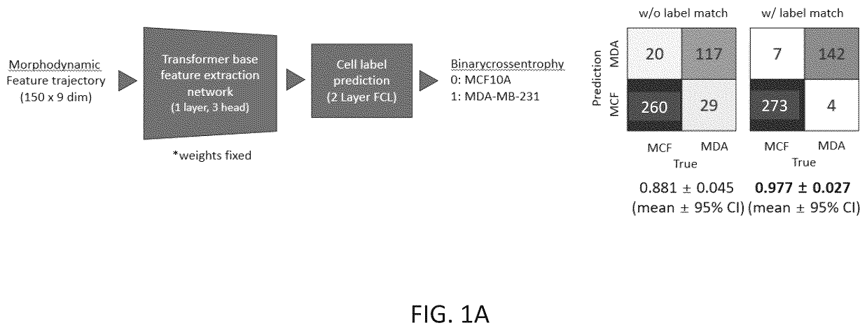

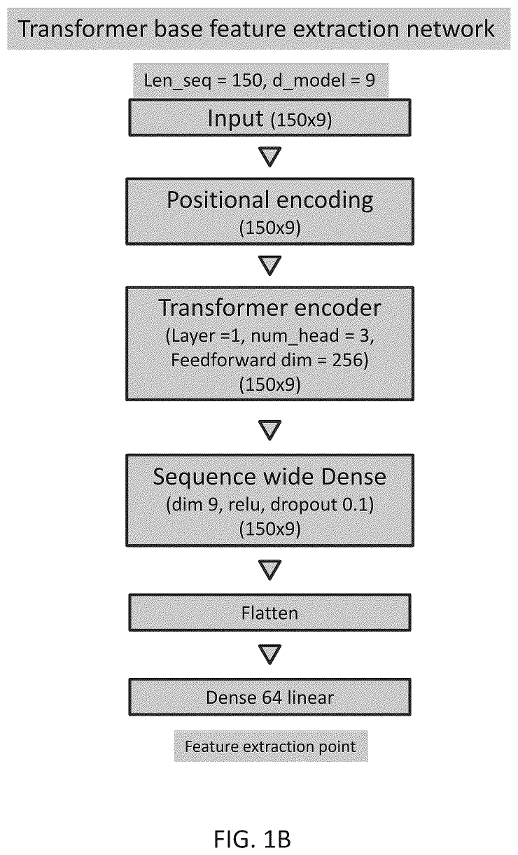

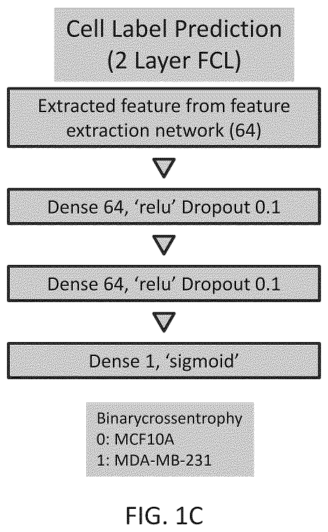

In technique 1000, sub-act 1006b follows sub-act 1006a. Sub-act 1006b includes processing the plurality of feature value trajectories using the encoder portion of the trained neural network model to obtain a numeric embedding of the plurality of feature value trajectories. A “numeric embedding” of a feature value trajectory comprises lower dimensional data that represents the higher dimensional feature value trajectory. In some embodiments, the numeric embedding is a 64-dimensional representation of the plurality of feature value trajectories of the cell. In some embodiments, the encoder portion of the trained neural network has a transformer-based architecture (e.g., see FIG. 1B). In some embodiments, the encoder portion of the trained neural network comprises multiple attention heads (e.g., 2, 3, 4, or more attention heads). In some embodiments, the encoder portion of the trained neural network comprises 1 layer. In some embodiments, the encoder portion of the trained neural network comprises 1, 2, 3, 4, 5, 6, 7, 8, 9, or 10 layers. In some embodiments, the encoder portion of the trained neural network comprises 1 fully connected layer. In some embodiments, the encoder portion of the trained neural network comprises 1, 2, 3, 4, 5, 6, 7, 8, 9, or 10 fully connected layers. In some embodiments, the encoder portion of the trained neural network comprises at least 1 fully connected layer. In some embodiments, the encoder portion of the trained neural network comprises a feed forward layer. In some embodiments, the trained neural network comprises at least 10 parameters, (e.g., at least 100 parameters, at least 1000 parameters, at least 10,000 parameters, at least 100,000 parameters, or at least 1,000,000 parameters. In some embodiments, the trained neural network comprises 10 to 100 parameters. In some embodiments, the trained neural network comprises 10 to 1,000 parameters. In some embodiments, the trained neural network comprises 10 to 10,000 parameters. In some embodiments, the trained neural network comprises 10 to 1,000,000 thousand parameters. In some embodiments, the trained neural network comprises 100 to 1,000 parameters. In some embodiments, the trained neural network comprises 100 to 10,000 parameters. In some embodiments, the trained neural network comprises 100 to 1,000,000 thousand parameters. In some embodiments, the trained neural network comprises 1,000 to 10,000 parameters. In some embodiments, the trained neural network comprises 1,000 to 1,000,000 thousand parameters. In some embodiments, processing the feature value trajectories with the neural network encoder comprises calculating a numeric embedding using: (1) the values of the feature trajectories; and (2) the values of the parameters of the neural network.

In technique 1000, sub-act 1006c follows sub-act 1006b. Sub-act 1006c includes processing the numeric embedding using the classification portion of the trained neural network model to identify the type of the particular cell. In some embodiments, the classification portion of the trained neural network model comprises at least 2 layers (e.g., at least 3 layers, at least 4 layers or at least 5 layers). In some embodiments, the classification portion of the trained neural network model comprises 1, 2, 3, 4, or 5 layers. In some embodiments, the classification portion of the trained neural network model comprises a first layer and a second layer. In some embodiments, the first layer comprises a first non-linear activation function (e.g., a first rectified linear unit (ReLU)). In some embodiments, the second layer comprises a second non-linear activation function (e.g., a second rectified linear unit (ReLU)). In some embodiments, the classification portion of the trained neural network model comprises an output layer comprising that applies a sigmoid function (e.g., for use in binary cell type classification like cancer cell type or normal cell type) (e.g., see FIG. 1C).

In some embodiments, the method comprises training the trained neural network. In some embodiments, training the trained neural network comprising generating training data for training the encoder portion; and training the encoder portion using the generated training data.

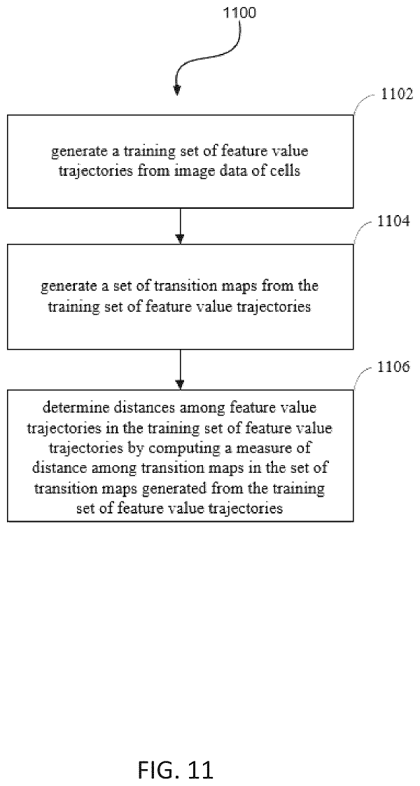

FIG. 11 is a diagram depicting illustrative technique 1100 for generating training data for use in training the encoder portion of the trained neural network. Technique 1100 includes act 1102, generating a training set of feature value trajectories from image data of cells. In some embodiments, generating a training set of feature value trajectories from image data of cells comprises generating the training set of feature value trajectories from labeled image data of cells (e.g., data where cell type of the cells in known). Any suitable means may be used to determine feature value trajectories, including the methods described with reference to Technique 1100. In some embodiments, the cell types selected for imaging and corresponding generating of a training set of feature values trajectories are selected based on the task of the trained neural network. For example, if the task of the trained neural network is to classify breast cancer cells and normal breast cells then breast cancer cells and normal breast cells may be selected for use in generating the training set of feature value trajectories.

Technique 1100 continues with act 1104, generating a set of transition maps from the training set of feature value trajectories. A transition map may be generated from the training set of feature value trajectories in any suitable way. In some embodiments, generating a set of transition maps comprises generating a first transition map in the set of transition maps from a first feature value trajectory (e.g., a trajectory of cell area) in the set of feature value trajectories, wherein generating the first transition map from the first feature value trajectory comprises: determining in a set of states defined in feature space having fewer dimensions than the number of features in the plurality of features, a transition probability matrix (e.g., a transition map) among the set of states based on how the first feature value trajectory overlaps with the set of states. In some embodiments, obtaining a feature space having few dimensions that the number of feature in the plurality of features comprises apply a dimension reduction method to the feature space (e.g., PCA, Kernel PCA, graph-based Kernel PCA, ICA, manifold learning, isomap, locally linear embedding, laplacian eigenmaps, linear discriminant analysis, auto-encoding, t-distributed stochastic neighbor embedding (t-SNE) UMAP, PaCMAp (pairwise controlled manifold approximation) non-negative matrix factorization (NMF), or uniform manifold approximation and projection (UMAP). In some embodiments, the method comprises determining a set of transition maps for at least some of the cells of the plurality of cells of the segmented cell data (e.g., at least 10%, at least 20%, at least 25%, at least 50%, at least 75%, at least 90%, at least 95%, at least 98%, and at least 99% of the cells of the plurality of cell of the segmented data). In some embodiments, the method comprises determining a set of transition maps each of the cells of the plurality of cells of the segmented cell data. In some embodiments, the feature value trajectory comprises at least 3 dimensions (e.g., at least 4 dimensions, at least 5 dimensions, at least 6 dimensions, at least 7 dimensions, at least 8 dimensions, at least 9 dimensions, or at least 10 dimensions) and a corresponding transition map has two dimensions (e.g., a first component and a second component of a dimension reduction method).

Technique 1100 continues with act 1106, determining distances among feature value trajectories in the training set of feature value trajectories by computing a measure of distance among transition maps in the set of transition maps generated from the training set of feature value trajectories. In some embodiments, determining a distance comprises determining a distance between a first feature value trajectory of a first cell and a second feature value trajectory of a second cell by determining a measure of distance between a first transition map of the first cell and a second transition map of the second cell. In some embodiments, the first cell and the second cell are the same cell type. In some embodiments, the first cell and the second cell are different cell types (e.g., a cancerous cell and a normal cell). Determining a measure of distance may be performed in any suitable manner. In some embodiments, determining measure of distance comprises determining a Kolmogorov-Smirnov Distance, an Earth Mover's Distance or a Cramér-von Mises Distance. Measures of distance determined in act 1106 may then be used as ground truth to train the encoder portion of the trained neural network.

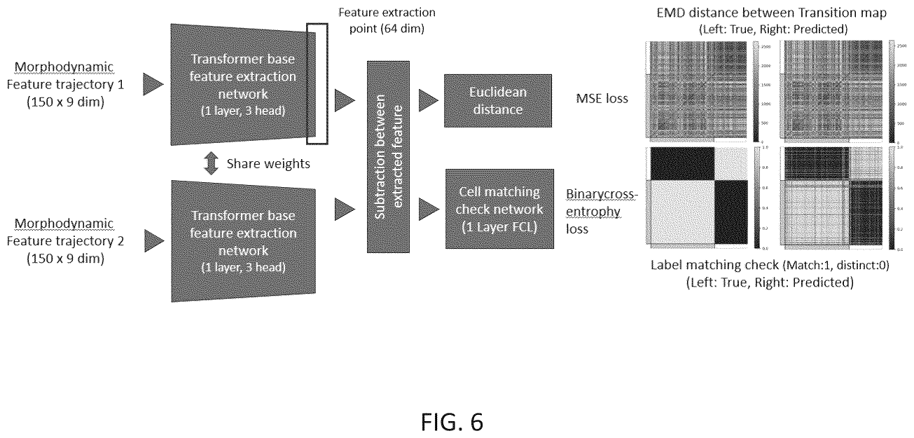

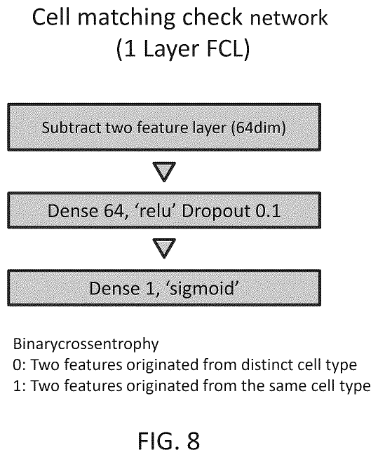

Any suitable means may be used to train the encoder portion of the trained neural network. In some embodiments, training the encoder portion of the trained neural network comprises training the encoder using a measure of distance between transition maps of a pair of cells as a ground truth of distance between two different cells (e.g., a pair of cell of the same type or a pair of cells of different types). In some embodiments, training the encoder portion of the trained neural network comprises training neural network comprising a transformer based architecture. In some embodiments, training the encoder portion of the trained neural network comprises training using a Siamese transformer network. In some embodiments, training comprises training a Siamese transformer network to estimate a distance among a pair of feature value trajectories (e.g., feature value trajectories of a first and a second cell). In some embodiments, determining distances among the pair of feature value trajectories comprises determining, using a Siamese transformer network (FIG. 6), a pair of numeric embeddings corresponding to the pair of feature value trajectories inputted and determining a distance (e.g., difference) among the numeric embeddings of the pair. In some embodiments, to train the encoder model parameters, distances among the feature value trajectories may be compared to a ground truth distance among the feature value trajectories (e.g., a ground truth distance between a transition map of the first cell and a transition map of a second cell). Any suitable means may be used to compare the of distances among the feature value trajectories generated by the encoder portion (dFVT output) and the ground truth distance (ground truth). In some embodiments, comparison is performed by determining a distance among the dFVT output and the ground truth. In some embodiments, determining a distance comprises determining one or more of a Dot product, Euclidean distance, Manhattan distance or cosine distance among the dFVT output and the ground truth. In some embodiments, determining a distance among the dFVT output and the ground truth comprises determining one or more of Dot product, Euclidean distance, Manhattan distance, cosine distance or a distance determined by a trained machine learning model. In some embodiments, determining distance using the trained machine learning model comprises determining distance using a cell matching check network (e.g., see FIG. 8). For example, a cell matching check network may input dFVT and the ground truth and output a distance. In some embodiments, the cell matching check network comprises 1 fully connected layer. In some embodiments, the cell matching check network comprises at least 1 fully connected layer. In some embodiments, determining distance comprises determining Euclidean distance and/or cell matching check network distance among the dFVT output and the ground truth. In some embodiments, the distance between the dFVT and the ground truth is used to train the encoder portion. Training the encoder portion may be performed with any suitable algorithm (e.g., mean-squared error loss or binary cross-entropy loss).

In some aspects, this disclosure provides a method comprising two parts, each comprising multiple steps. In some embodiments, the first part involves defining the similarity between time series data, and the steps are as follows: (1) extracting features that capture snapshot states; (2) dividing these snapshot information into multiple states using techniques such as positional splitting or clustering; (3) converting the time series data into a transition chain between snapshot states; (4) collecting transitions from the transition chain and form a histogram of these transitions; and (5) comparing these histograms to define the similarity between time series. In some embodiments, the second part comprises applying this similarity information to deep learning models e.g., using a Siamese training approach. In some embodiments, a Siamese model takes two time series as input and predicts a similarity value calculated from the first part. Additionally, other information of interest can be incorporated by adding an extra output that compares these specific aspects.

In some embodiments, this disclosure provides a method of converting time series data (e.g., a series of images of the plurality of cells) into a transition map. In some embodiments, the method comprises: obtaining time series data (e.g., cell imaging data); extracting a plurality of features from the time series data (e.g., cell morphodynamics features); deriving a plurality of feature value trajectories for a respective plurality of the extracted features; reducing the dimensions of the plurality of feature value trajectories to obtain reduced dimension feature value trajectories; converting the reduced dimension feature value trajectories into a chain of states; and determining transitions between states in the chain of states to produce a transition map.

In some embodiments, the method comprises segmenting objects (e.g., individual cells) of the time series data into a plurality of segmented objects to obtain segmented time series data; extracting a plurality of features from the segmented time series data (e.g., cell morphodynamics features); deriving a plurality of feature value trajectories for a respective plurality of the extracted features for at least some of the objects (e.g., most of or all of the objects) of the segmented time series data; reducing the dimensions of the plurality of feature value trajectories to obtain a plurality of reduced dimension feature value trajectories; converting the plurality of reduced dimension feature value trajectories into a plurality of chains of states; and determining, for at least some of (e.g., most of or all of) the plurality of chains of states, transitions between states in the chain of states to produce a plurality of transition maps.

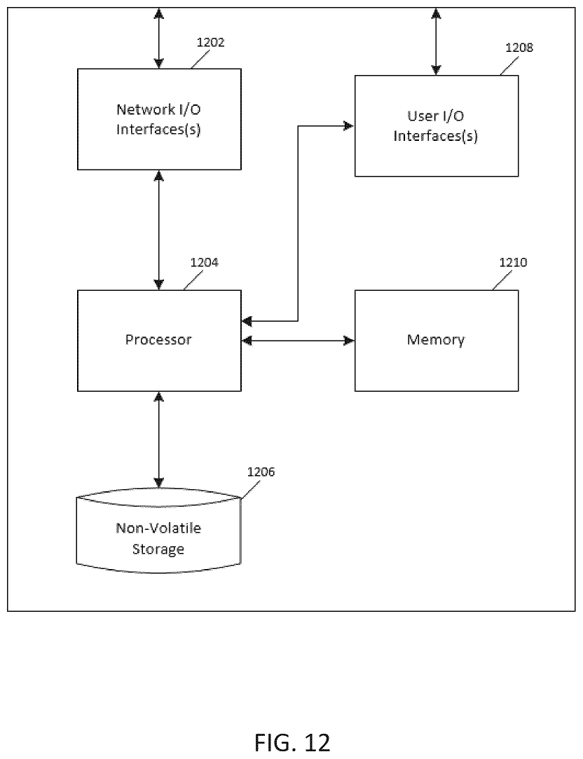

In some embodiments, a transition map is a histogram of state transitions. In some embodiments, a method comprises, for at least 2 sets of time series data, converting each set of times series data into a transition map. In some embodiments, a method comprises, for a plurality of set of time series data (e.g., 1, 2, 3, 4, 5, 6, 7, 8, 9, or 10 sets of time series data), converting each set of times series data of the plurality of sets of time series data into a transition map. In some embodiments, the method further comprises training a machine learning model using the transition map. In some embodiments, converting time series data comprises converting first time series data to produce a first transition map and converting second time series data to produce a second transition map. In some embodiments, the method further comprises training a machine learning model using a measure of distance (e.g., earth mover's distance) between the first transition map and the second transition map. In some embodiments, training the machine learning model comprises training the machine learning model to determine a distance between the first transition map and the second transition map. An illustrative implementation of a computer system 1200 that may be used in connection with any of the embodiments of the technology described herein (e.g., such as the process of FIGS. 10 and 11) is shown in FIG. 12. The computer system 1200 includes one or more processors 1204 and one or more articles of manufacture that comprise non-transitory computer-readable storage media (e.g., memory 1210 and one or more non-volatile storage media 1206). The processor 1204 may control writing data to and reading data from the memory 1210 and the non-volatile storage device 1206 in any suitable manner, as the aspects of the technology described herein are not limited to any particular techniques for writing or reading data. To perform any of the functionality described herein, the processor 1204 may execute one or more processor-executable instructions stored in one or more non-transitory computer-readable storage media (e.g., the memory 1210), which may serve as non-transitory computer-readable storage media storing processor-executable instructions for execution by the processor 1204.

Computer system device 1200 may also include a network input/output (I/O) interface 1202 via which the computer system may communicate with other computing devices (e.g., over a network), and may also include one or more user I/O interfaces 1208, via which the computer system may provide output to and receive input from a user. The user I/O interfaces 1208 may include devices such as a keyboard, a mouse, a microphone, a display device (e.g., a monitor or touch screen), speakers, a camera, and/or various other types of I/O devices.

The above-described embodiments can be implemented in any of numerous ways. For example, the embodiments may be implemented using hardware, software, or a combination thereof. When implemented in software, the software code can be executed on any suitable processor (e.g., a microprocessor) or collection of processors, whether provided in a single computing device or distributed among multiple computing devices. Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone, a tablet, or any other suitable portable or fixed electronic device.

In this respect, it should be appreciated that one implementation of the embodiments described herein comprises at least one non-transitory computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-described functions of one or more embodiments (e.g., part of or all of the processes described above with reference to FIGS. 10 and 11). The computer-readable medium may be transportable such that the program stored thereon can be loaded onto any computing device to implement aspects of the techniques described herein. In addition, it should be appreciated that the reference to a computer program which, when executed, performs any of the above-described functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques described herein. Additionally, it should be appreciated that according to one aspect, one or more computer programs that when executed perform methods of the present disclosure need not reside on a single computer or processor, but may be distributed in a modular fashion among a number of different computers or processors to implement various aspects of the present disclosure.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. In some embodiments, computer readable media may be non-transitory media.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey a relationship between the fields. However, any suitable mechanism may be used to establish a relationship between information in fields of a data structure, including through the use of pointers, tags or other mechanisms that establish a relationship between data elements.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

### EXAMPLES

### Example 1: Classifying Cell Type

Early cancer detection is crucial for improving patient outcomes and survival rates. Among the various cancer detection methods—such as imaging and blood testing—biopsy remains indispensable. Currently, tissue imaging using cancer cell biomarkers plays a vital role in biopsies. However, effective cancer diagnosis requires the use of multiple markers, which increases both the cost and time involved.

An alternative label-free imaging method for cancer cell diagnosis relies on the distinct behavior of cancer cells compared to normal cells. Cancer cells, characterized by their aggressive invasion ability, exhibit differences in morphology. While numerous studies have utilized static snapshots of cells combined with artificial intelligence techniques, the accuracy of these methods remains insufficient. Since cell morphology constantly changes over time, a cell's morphology at a given time may be limited in reflecting the cell's true internal states. To address this issue, a machine learning approach was developed to analyze the morphodynamics of cancer cells, which considers the morphological trajectories of cancer cells (FIGS. 1A-1C). The machine learning approach has the following acts. First time-series live-cell imaging data is dimension reduced to produce a feature value trajectory. The feature value trajectory contains features which differentiate between different cell types (e.g., cell area, perimeter, and velocity). The feature value trajectory is inputting into machine learning model comprising an encoder portion, which reduces the dimensionality of the feature value trajectories to produce a numeric embedding. The encoder portion is a trained transformer-based neural network (FIG. 1B). The numeric embedding is inputted into a classifier portion (FIG. 1C) to produce a cell type. This process was shown to classify normal and cancerous breast cancer cells.

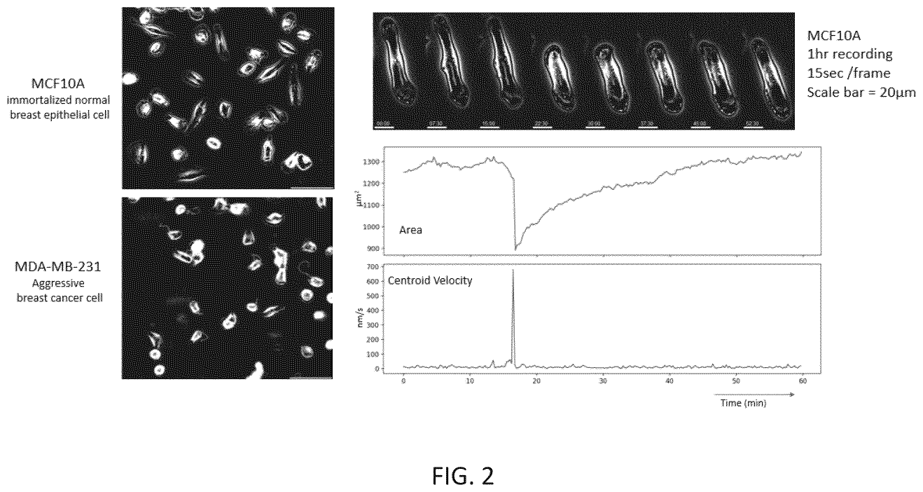

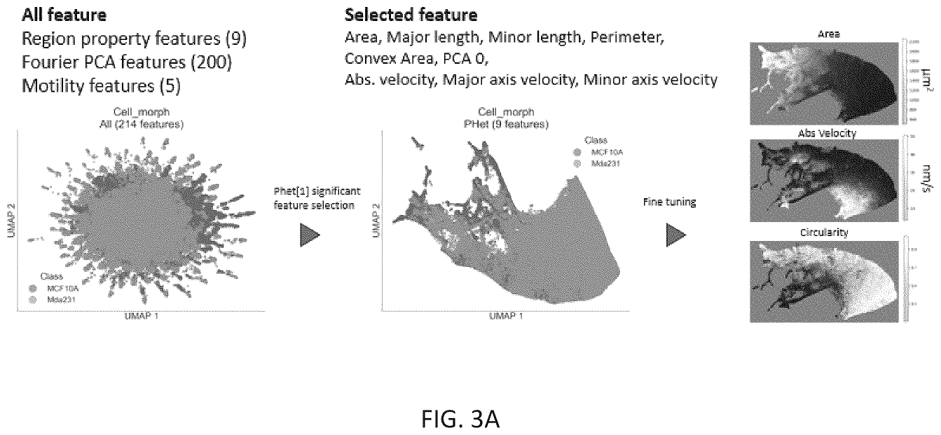

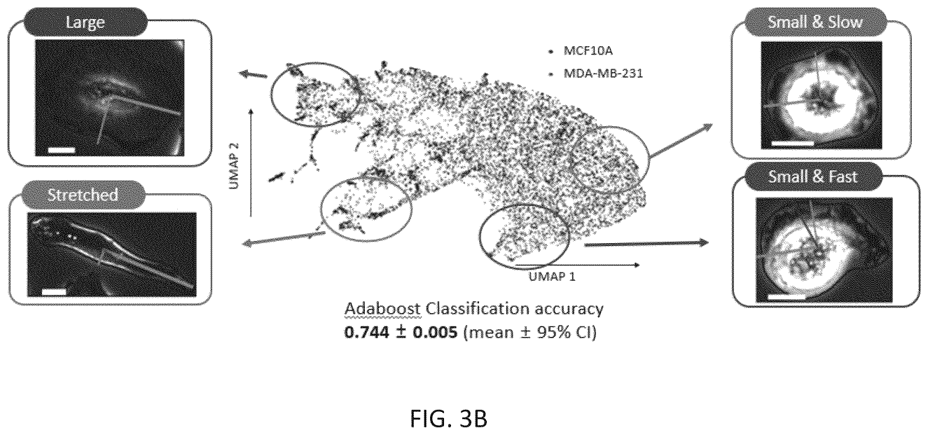

Phase-contrast movies of MCF10A (normal) and MDA-MB-231 (cancer) cells at 15-second intervals over an hour were captured (FIG. 2). Following cell segmentation and tracking, both standard morphological and velocity features were extracted. PHet-based feature selection was utilized to pinpoint a subset of significant features that clearly distinguish between the two cell lines (FIG. 3A). Utilizing these features, a UMAP space was generated to represent snapshots of cell states (FIG. 3B). To delve deeper into the progression of these morphodynamic states, trajectory embedding was implemented, aiming to discern cell subpopulations characterized by unique morphodynamic trajectories.

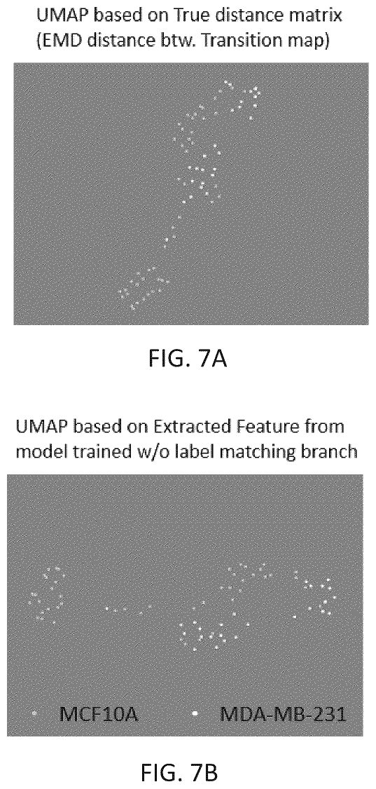

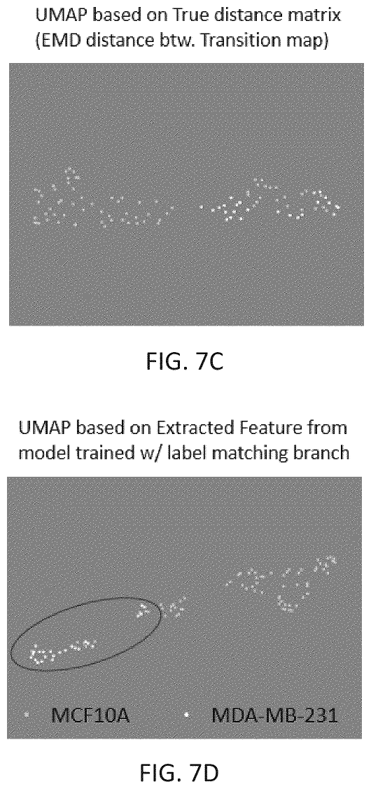

Analysis of heterogeneous cellular trajectories is challenging and requires an embedding method that accounts for timing and randomness issues. A method to quantify the distance between different cellular trajectories was developed, which serves as a teacher model to train a Transformer-based student model (FIG. 6). This approach not only enhances accuracy but also provides better interpretability for the reasons behind classification (FIGS. 7A-7D).

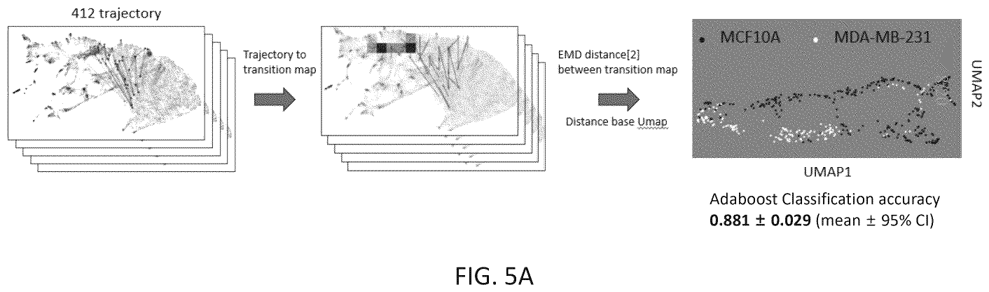

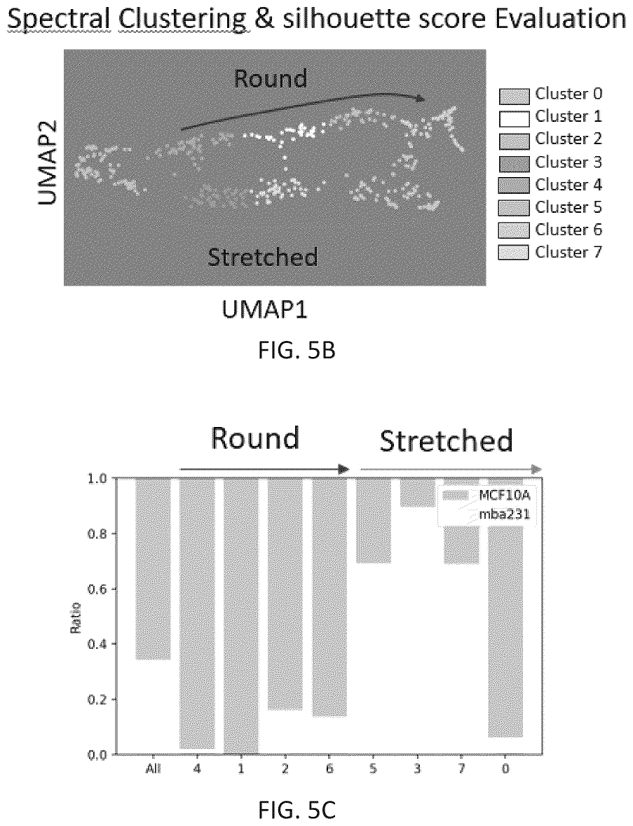

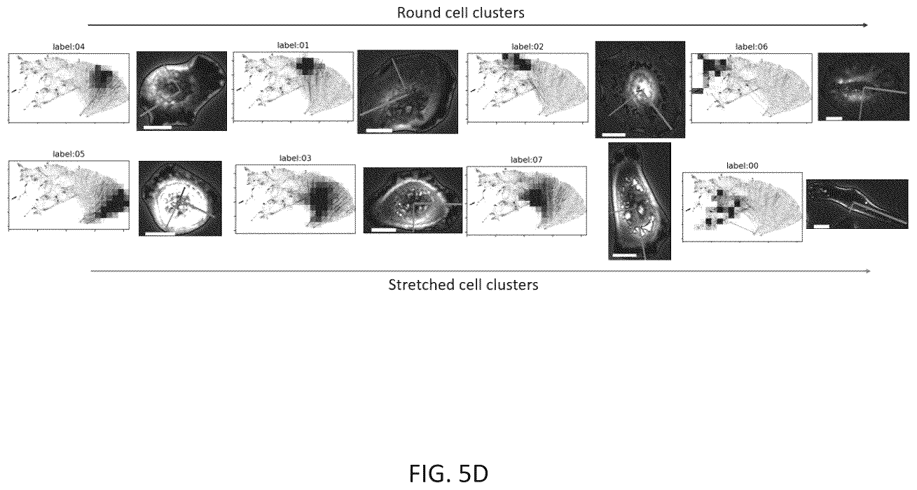

Transformer-based student model inputs a feature value trajectory associated with a given cell and output a numerical embedding that is in turn used by a classifier to determine a corresponding cell type. The features of the feature vectors were determined using PHet (MA Basher, A. R., Hallinan, C., & Lee, K. (2023). BioRxiv, 2023-2025). The Transformer-based student model was trained using a ground truth derived from transition maps of the training data comprising feature value trajectories. In summary, the feature value trajectories (9 dimensions) were converted into transition maps (2 dimensions) that represented the probability of transitions from one cell state to another between adjacent grids (e.g., the probably of a cell changes from a first length to a second length between temporally adjacent images in the live cell imaging data (FIGS. 5A-5D).

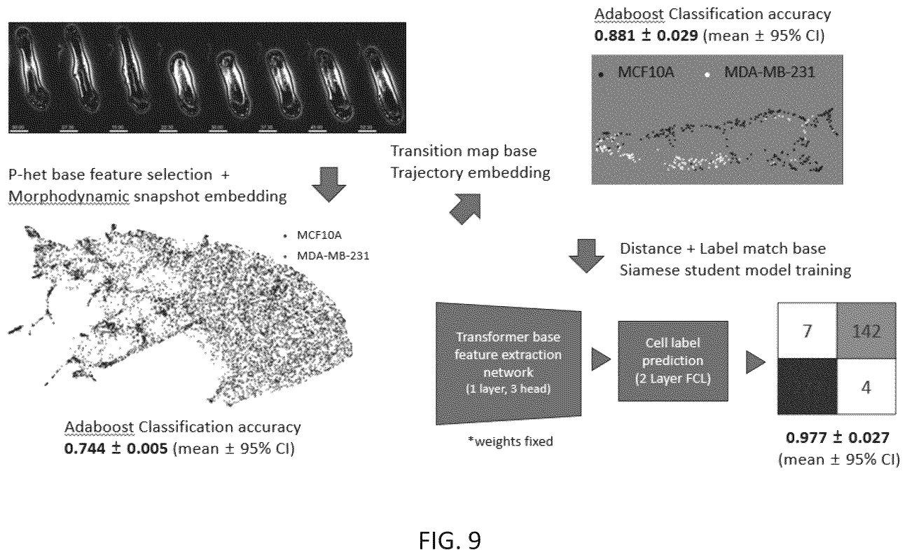

The trajectory embedding method significantly improves cell classification accuracy between MCF10A (normal) and MDA-MB-231 (cancer) cells, increasing it from approximately 70% (achieved with snapshot embedding) to around 90% (FIG. 9). This advancement holds promise for significantly improving the accuracy and interpretability of live-cell-based cancer cell diagnosis.

Overall, this method offers a significant advancement in the field of time series analysis by converting temporal data into trajectory embedding, thereby improving the detection and analysis of patterns obscured by heterogeneity and stochastic fluctuations. This method presents a more accurate and insightful tool for researchers and practitioners across various domains, providing a scalable and flexible approach to time series analysis.

### Methods

### Segmenting

Segmenting live cell images can include segmenting using MARS-Net. Then, along with cell tracking, the time-series of diverse morphological features can be extracted. To model their temporal dependency relationships, the vector autoregressive (VAR) model may be utilized, where each feature value is expressed as a linear combination of its previous values and those of other feature variables within a defined period. Prior to modeling, differencing was applied to non-stationary data to make them stationary. After modeling, coefficients reflecting the influence from the ith to the jth feature in the previous kth order will be acquired and concatenated to create a feature vector representing morphodynamics of each cell.

### Dimensional Reduction

This stage employs dimensional reduction techniques, including Uniform Manifold Approximation and Projection (UMAP), Principal Component Analysis (PCA), or other time-series feature extraction, to reduce the dimensionality of the time series live cell imaging data at each time point. The reduced feature space is then divided into discrete grids. A state transition was defined as a movement between temporally adjacent grid states. This act manages the high-dimensional nature of time series data and identifies meaningful states that the system transitions through over time.

Feature selection involves reducing the number of features for subsequent computational analyses. Traditional algorithms in this area primarily focus on identifying features for classifying known disease states, which often leads to simplifying the disease feature space by eliminating heterogeneous features. PHet is used uncover informative heterogeneity-preserving features for subtype discovery from omics expression data. PHet integrates the role of AIQR discovered by using DML in an iterative subsampling framework. It begins by annotating the data with binary conditions (e.g., Normal vs Cancer). This data is directed to the PHet pipeline consisting of six major acts. (i) Iterative subsampling to calculate p-values, using t-test or z-test, and absolute interquartile range differences ΔIQR for each feature among different conditions. The p-values measure the statistical significance of the difference in expression levels between the two groups, while the ΔIQR values indicate the differences in variability of the expression between each group. To ensure capturing sufficient diversity of features among samples that help identify subtypes, the subsampling procedure is repeated for a predefined number of iterations. Immediately, the Fisher's combined probability test (ii) is then applied to summarize the collected p-values. The results from this test serve as prior information to calculating features statistics and ranking. (iii) A weighted features profile is constructed using the nonparametric two-sample Kolmogorov-Smirnov (KS) test between control and case samples to map each feature to its profile. The KS test is used to identify discriminative features that exhibit maximum difference from long-run distribution (cumulative distribution functions) between control and case samples. At the same time, this test has the potential to eliminate redundant discriminative features by minimizing their scores. This is achieved by binning the p-values from the KS test into a predefined number of intervals, where each interval is associated with a weight denoting a feature profile. (iv) Feature statistics are estimated using a combination of the ΔIQR values, feature profiles, and Fisher's combined probability scores. (v) Feature statistics are fitted using the gamma distribution, and features exceeding a user threshold, 0.01 are trimmed. Finally, appropriate dimensionality reduction and clustering methods (vi) are performed on the reduced omics data, having only those selected features from act (v), to reconstruct data heterogeneity.

Trajectories of snapshot features can be represented as follows: The feature space is represented using a grid and each square on the grid is treated as a distinct state. State transition is defined as a step movement between temporally adjacent grid states, which can represent 4-dimensional information derived from a 2-dimensional feature space. By aggregating these transitions from a trajectory, a 4-dimensional histogram of state transitions can be created, referred to as “transition map”. This map can be visualized using blue histograms to indicate the proportion of the preceding state and red arrows to denote mean state changes from each grid state. The separation (distance) between transition maps is measured using methods including the Earth Mover's Distance, also known as the Wasserstein distance. This distance between trajectories allows for the creation of a UMAP space for trajectory embedding. This metric allows for a quantifiable comparison of the similarity between different time series, facilitating the identification of patterns and trends that might not be apparent through traditional methods.

### Training Machine Learning Models

The final stage involved training machine learning models, including Transformers, using the similarity between different time series (FIG. 6). The training process involves training the encoder to reduce the dimensions of the feature value trajectories into a numeric embedding. Feature value trajectories of a pair of cells were separately inputted into the encoder to produce a pair of numeric embeddings. The distance between the pair of numeric embedding was determined (e.g., using Euclidian distance and/or a cell matching check network). The ground truth for training was the Earth Mover's distance between state transition maps of a pair of cells. Training is performed using one or more loss functions such as mean-squared error (MSE) or cross-entropy loss. After training, the trajectory embeddings were extracted from the trained models and utilized for various supervised and unsupervised learning tasks (e.g., classification of cell type).

### Phenotype Discovery

The selected features can be further reduced by manifold learning, UMAP, to find the low-dimensional manifold where the meaningful phenotypic features are distributed. This process allows visualization of the distribution of the data and data clustering. Using the UMAP features, the density peak clustering algorithm, community detection, and DBSCAN can be applied. Three criteria were considered to select clusters: Davies-Bouldin index45, average silhouette, and Calinski-Harabasz pseudo F-statistic. After the data are clustered, the proportions of each phenotype in each condition are quantified. The statistical testing is performed using bootstrapping resampling without relying on Gaussian assumption. Also, the effector size in each subtype will be quantified.

### Example 2: Determining a Transition Map

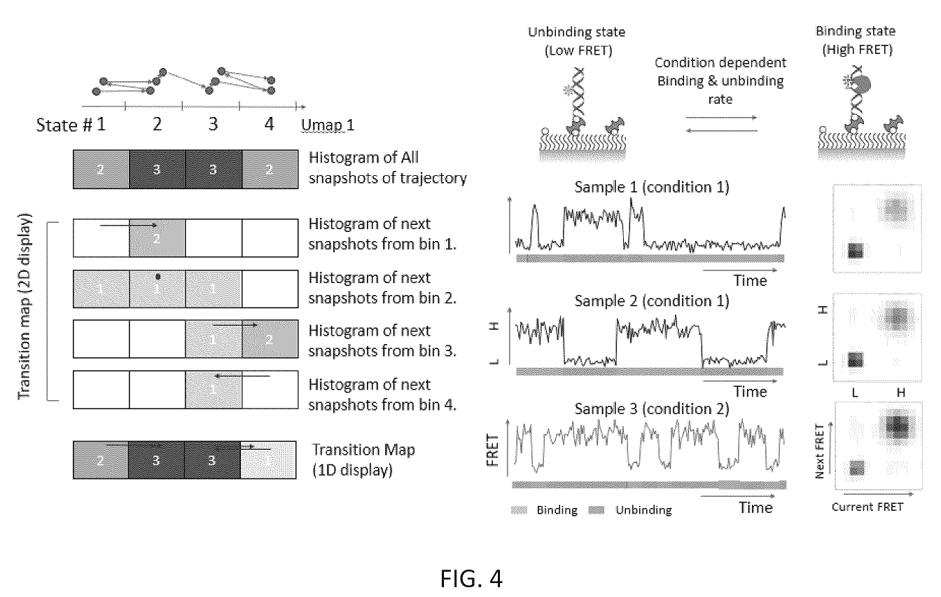

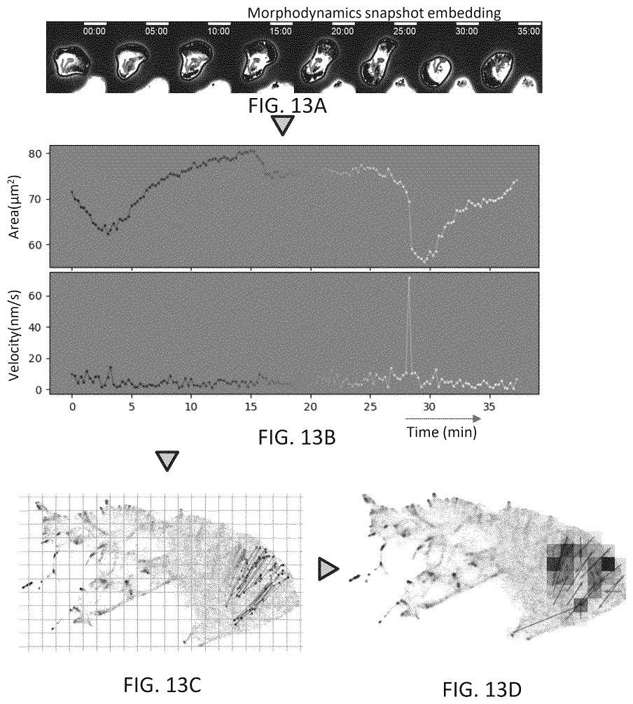

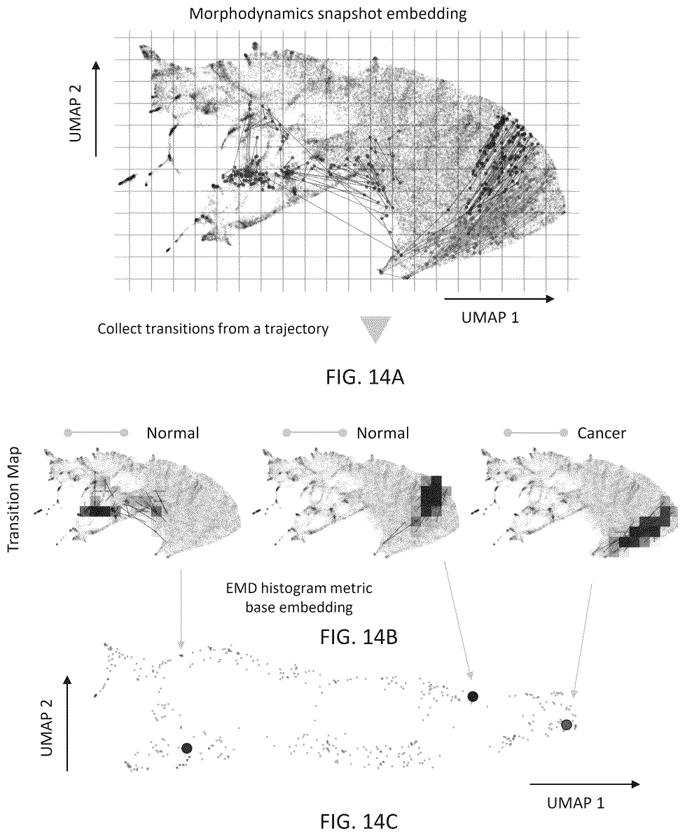

Provided is an exemplary method for determining a transition map including the following described steps: (1) Collecting single-cell movies (FIGS. 14A-14C). By applying cell segmentation and tracking algorithms, cell shape movies (FIG. 13A) and extracted trajectories of snapshot features (FIG. 13B) were defined. (2) Although many features can describe a cell's morphodynamics, not all are suitable for classification. To select only the most significant features, feature selection algorithm (PHet) was used to assess their relevance for a given class. (3) Next, a low-dimensional space for the time-series data was defined. A dimensional reduction method was applied to project the selected snapshot features into this low-dimensional space, revealing trajectories of the features within that space (FIG. 13C). (4) States were then defined to transform these low-dimensional time series into chains of state transitions by a grid-based state separation (FIG. 13C). By overlaying a grid on the low-dimensional space and treating each grid cell as a distinct state, the time series was converted into a chain of states. (5) From this state-transition chain, each snapshot state transition was collected and compiled into a histogram (FIG. 4, FIG. 13D), which was referred to as the Transition Map. (6) Each cell movies can be converted into a trajectory in the low-dimensional space (FIG. 14A) and then into a Transition Map (FIG. 14B). A histogram comparison metric is used to measure similarity between Transition Maps. In the case of similarity between states can be defined, Earth Mover's Distance base histogram compare algorithm can be used. In the other case, like categorical states that cannot define similarity between states, Euclidean distance can be a choice of distance metric. Once the distances between time series are calculated, an embedding space of each cell's long-term morphodynamics can be defined (FIG. 14C).

What is claimed is:

1. A method for identifying cell types of one or more cells in a plurality of cells from a series of images of the plurality of cells, the method comprising:
using at least one computer hardware processor to perform:
obtaining the series of images of the plurality of cells, the series of images of the plurality of cells having been previously captured;
segmenting images in the series of images of the plurality of cells to obtain segmented cell data, the segmented cell data comprising segmented image data for each of at least some of the plurality of cells;
identifying each particular cell of the at least some of the plurality of cells as being of a type from a discrete set of cell types, the identifying being performed using segmented image data for the particular cell and a trained neural network model comprising an encoder portion and a classification portion, the identifying comprising:
deriving, from the segmented image data for the particular cell, a plurality of feature value trajectories for a respective plurality of features;
processing the plurality of feature value trajectories using the encoder portion of the trained neural network model to obtain a numeric embedding of the plurality of feature value trajectories; and
processing the numeric embedding using the classification portion of the trained neural network model to identify the type of the particular cell.

2. The method of claim 1, wherein the encoder portion of the trained neural network has a transformer based architecture.

3. The method of claim 1, wherein the encoder portion comprises multiple attention heads.

4. The method of claim 1, wherein the classification portion of the trained neural network comprises at least one fully connected layer.

5. The method of claim 1,
wherein the plurality of features includes cell area, major length, minor length, perimeter, convex Area, PCA 0, abs. velocity, major axis velocity, and minor axis velocity;
wherein the segmented cell data comprises segmented image data for a first cell of the at least some of the plurality of cells;
wherein the segmented image data for the first cell comprises a sequence of images of the first cell; and
wherein deriving the plurality of feature value trajectories for the first cell comprises deriving feature values, for each of the plurality of features, from each of the images of the sequence of images of the first cell.

6. The method of claim 1, further comprising training the trained neural network model, the training comprising:
generating training data for training the encoder portion; and
training the encoder portion using the generated training data.

7. The method of claim 6, wherein generating the training data comprises:
generating a training set of feature value trajectories from image data of cells;
generating a set of transition maps from the training set of feature value trajectories; and
determining distances among feature value trajectories in the training set of feature value trajectories by computing a measure of distance among transition maps in the set of transition maps generated from the training set of feature value trajectories.

8. The method of claim 7,
wherein generating the set of transition maps from the training set of feature value trajectories comprises generating a first transition map in the set of transition maps from a first feature value trajectory in the set of feature value trajectories,
wherein generating the first transition map from the first feature value trajectory comprises:
determining in a set of states defined in feature space having fewer dimensions than the number of features in the plurality of features, a transition probability matrix among the set of states based on how the first feature value trajectory overlaps with the set of states.

9. (canceled)

10. The method of claim 7, wherein training the encoder portion using the generated training data comprises:
training a Siamese transformer network to estimate distances between pairs of feature value trajectories, from among the training set of feature value trajectories, as inputs and determined distances among the feature value trajectories as outputs,
wherein the Siamese transformer network comprises the encoder portion.

11-12. (canceled)

13. The method of claim 6, further comprising training the classification portion of the trained neural network.

14. A method for identifying cell types of one or more cells in a plurality of cells from a series of images of the plurality of cells, the method comprising:
using at least one computer hardware processor to perform:
obtaining the series of images of the plurality of cells, the series of images of the plurality of cells having been previously captured;
segmenting images in the series of images of the plurality of cells to obtain segmented cell data, the segmented cell data comprising segmented image data for each of at least some of the plurality of cells;
identifying each particular cell of the at least some of the plurality of cells as being of a type from a discrete set of cell types, the identifying being performed using segmented image data for the particular cell, a trained encoder neural network model, and a trained classification model, the identifying comprising:
deriving, from the segmented image data for the particular cell, a plurality of feature value trajectories for a respective plurality of features;
processing the plurality of feature value trajectories using the trained encoder neural network model to obtain a numeric embedding of the plurality of feature value trajectories; and
processing the numeric embedding using the trained classification model to identify the type of the particular cell.

15. The method of claim 14, wherein the trained classification model is a neural network model, a support vector machine, a linear regression model, a non-linear regression model, a Bayesian model, or a graphical model.

16. (canceled)

17. The method of claim 1, wherein the method further comprises: capturing the series of images of the plurality of cells.

18. A method of converting time series data into a transition map, the method comprising:
obtaining time series data;
extracting a plurality of features from the time series data;
deriving a plurality of feature value trajectories for a respective plurality of the extracted features;
reducing the dimensions of the plurality of feature value trajectories to obtain reduced dimension feature value trajectories;
converting the reduced dimension feature value trajectories into a chain of states; and
determining transitions between states in the chain of states to produce a transition map.

19. The method of claim 18, wherein obtaining the time series data comprises obtaining a series of images of the plurality of cells; and
wherein extracting the features from the time series data comprises extracting cell morphodynamics features.

20. The method of claim 18, further comprising training a machine learning model using the transition map.

21. The method of claim 18, wherein converting time series data comprises converting first time series data to produce a first transition map and converting second time series data to produce a second transition map.

22. The method of claim 21, further comprising training a machine learning model using a measure of distance between the first transition map and the second transition map.

23. (canceled)

24. A system, comprising:
at least one computer hardware processor; and
at least one non-transitory computer-readable storage medium that, when executed by the at least one computer hardware processor, causes the at least one computer hardware processor to perform the method of claim 1.

25. At least one non-transitory computer-readable storage medium that, when executed by at least one computer hardware processor, causes the at least one computer hardware processor to perform the method of claim 1.
